(19) United States
(12) Patent Application Publication
(10) Pub. No.: US 2007/0297581 A1
(43) Pub. Date: Dec. 27, 2007

(54) Voice-based phone system user interface

(75) Inventors: Yu-Ting Kuo, Sammamish, WA (US); Adwait Ratnaparkhi, Redmond, WA (US); Christopher S. Thrasher, Kirkland, WA (US); Jonathan J. Cadiz, Redmond, WA (US); Kuansan Wang, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/474,781

(22) Filed: Jun. 26, 2006

(51) Int. Cl. H04M 11/00

(52) U.S. Cl. 379/93.26

(57) ABSTRACT

Various technologies and techniques are disclosed that improve the operation of a telephone using spoken commands. A virtual operator service is accessed, such as by a single input of a user. A user speaks a telephone command, and the command is forwarded to the virtual operator service. The spoken command is recorded and translated by the virtual operator. An operation associated with the translated spoken command is performed, such as a voice dialing operation, a call transfer operation, a call park operation, a call conference operation, a call screening operation, an announcement operation, a broadcast operation, or a remote control device operation. The result of the operation, such as a connected call, is provided to the user. The virtual operator service can be accessed during an ongoing call, and the ongoing call is parked while the virtual operator receives and processes the new spoken telephone command from the user.

### BACKGROUND

Today, end users of advanced telephone systems (key systems, IP-PBXs, PBXs, etc.) require substantial advanced knowledge to use many of the advanced features the telephone systems offer, such as call transfer, call conferencing, call park and retrieve. It is also not convenient and sometimes not possible to access business contact information stored in users' computer or on their desktop (e.g. rolodex) using these advanced telephone systems if one is not physically in the office.

### SUMMARY

Various technologies and techniques are disclosed that improve the operation of a telephone using spoken commands. A virtual operator service is accessed, such as when the user presses a single button on a telephony phone or computer screen, or accesses the virtual operator service from an external phone. A user speaks a telephone command, and the command is forwarded to the virtual operator service over a network. The spoken command is recorded and translated by the virtual operator. An operation associated with the translated spoken command is performed, such as a voice dialing operation, a call transfer operation, a call park operation, a call conference operation, a call screening operation, an announcement for a public address system operation, a broadcast operation, or a remote control device operation. The result of the operation, such as a connected call, is provided to the user. The virtual operator service can be accessed during an ongoing telephone call, and the ongoing call is parked while the virtual operator receives and processes the new spoken telephone command from the user.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a telephone system of one implementation.

FIG. 2 is a diagrammatic view of a computer system of one implementation of the system of FIG. 1.

FIG. 3 is a diagrammatic view of a virtual operator application of one implementation operating on a computer system of FIGS. 1 and 2.

FIG. 4 is a process flow diagram for one implementation of the system of FIG. 1 illustrating the stages involved in allowing a user to speak a telephone command to a virtual operator.

FIG. 5 is a process flow diagram for one implementation of the system of FIG. 1 illustrating the stages involved in accessing a virtual operator from a client device.

FIG. 6 is a process flow diagram for one implementation of the system of FIG. 1 illustrating the stages involved in performing a voice dialing action using the virtual operator.

FIG. 7 is a process flow diagram for one implementation of the system of FIG. 1 that illustrates the stages involved in performing a call transfer action using a virtual operator.

FIG. 8 is a process flow diagram for one implementation of the system of FIG. 1 that illustrates the stages involved in performing a help action to help instruct a user on retrieving a parked call.

FIG. 9 is a process flow diagram for one implementation of the system of FIG. 1 that illustrates the stages involved in performing a call screening action using a virtual operator.

FIG. 10 is a process flow diagram for one implementation of the system of FIG. 1 that illustrates the stages involved in performing a call conferencing action using a virtual operator.

FIG. 11 is a process flow diagram for one implementation of the system of FIG. 1 illustrating the stages involved in accessing a virtual operator service from an external phone.

FIG. 12 is a process flow diagram for one implementation of the system of FIG. 1 illustrating the stages involved in allowing the user to access the virtual operator during an ongoing call.

FIG. 13 is a logical diagram of one implementation illustrating the flow of messages when the virtual operator is invoked.

FIG. 14 is a logical diagram of one implementation illustrating the flow of messages when a parked call is routed to another extension.

FIG. 15 is a process flow diagram for one implementation of the system of FIG. 1 illustrating the stages involved in providing supplemental info to help the user determine the next spoken command.

FIG. 16 is a diagram of a simulated telephone of one implementation that illustrates accessing the virtual operator using a single button.

FIG. 17 is a simulated screen for one implementation of the system of FIG. 1 that illustrates accessing the virtual operator using a single button.

FIG. 18 is a diagram of a simulated telephone of one implementation that illustrates providing supplemental information to help the user provide further spoken commands.

FIG. 19 is a simulated screen for one implementation of the system of FIG. 1 that illustrates providing supplemental information to help the user give further spoken commands.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as a telephone application, but the system also serves other purposes in addition to these. In one implementation, one or more of the techniques described herein can be implemented as features within a server-based voice-over-IP telephony program, or from any other type of program or service that manages telephone calls (e.g. audio and/or video telephone calls). In another implementation, one or more of the techniques described herein are implemented as features within a client-based voice-over-IP telephony program, or from other applications that receive telephone-related input from a user.

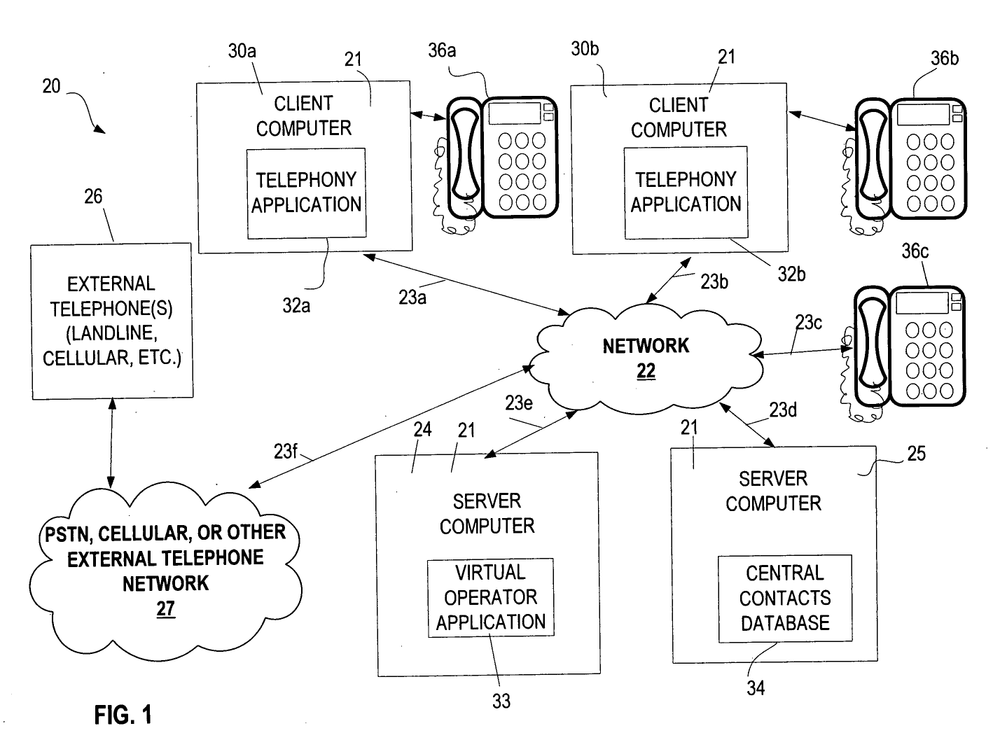

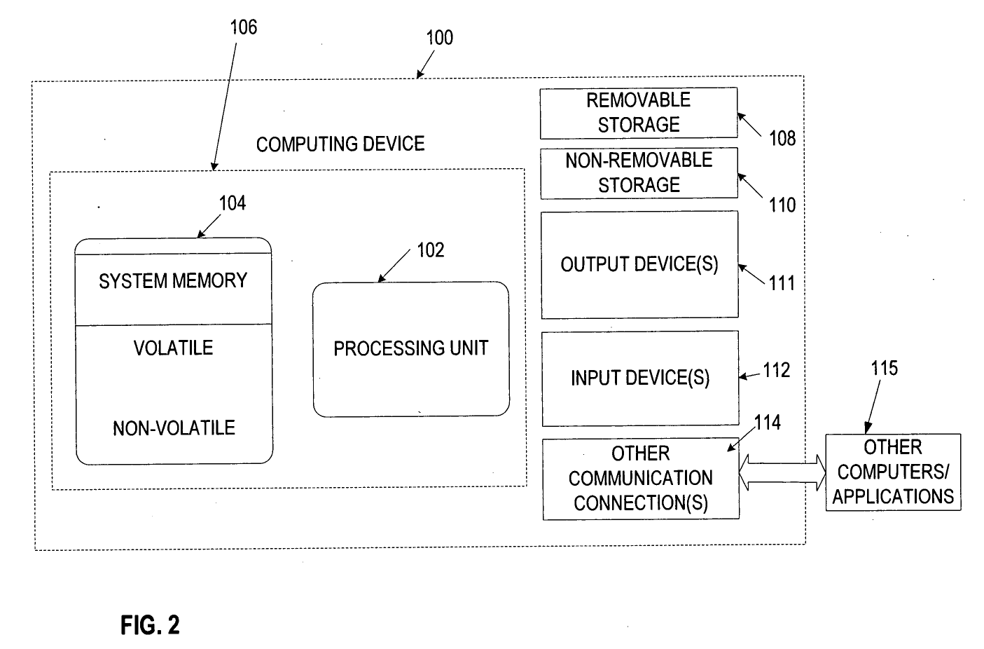

FIG. 1 is a diagrammatic view of a telephone system 20 of one implementation. Telephone system 20 has multiple computers 21, such as one or more client computers 30a and 30b, and one or more server computers 24 and 25. The typical configuration of computers 21 is described in more detail in FIG. 2 in the explanation of computing device 100. Computers 21 are coupled to network 22 over network pathways 23a, 23b, 23d, and 23e. Client computers 30a and 30b have telephony applications 32a and 32b, respectively that are responsible for interacting with telephony phones 36a and 36b, respectively. In the implementation shown, a telephony phone 36c is coupled directly to network 22 over communication pathway 23c without using a computer. In such an implementation, telephony phone 36c includes an adequate computing device internally, and thus does not require use of a separate computer. It will be appreciated that in other implementations, telephone system 20 may only include telephony phones (such as 36a and 36b) that are coupled to computers (such as 30a and 30b), or may only include telephony phones (such as 36c) that are coupled directly to network 22 without a computer.

In one implementation, server computer 24 has a virtual operator application 33 which is responsible for interacting with telephony applications (32a and/or 32b) and/or telephony phones (36a, 36b, and/or 36c). In one implementation, server computer 25 has a central contacts database 34 that is operable to store contacts information for one or more users instead of, or in addition contact information that may be stored on user's client computer (such as 30a and/or 30b) or elsewhere. Central contacts database 34 is operable to be accessed over network 22, allowing the user to access contacts information whether or not his/her personal client computer (such as 30a or 30b) is connected to network 22 at a particular moment. Network 22 can be accessed remotely over network pathway 23f by external telephones 26 using an external telephone network 27, such as packet-switched telephone network, cellular network, or another telephone network. Non-limiting examples of external telephones 26 include landline telephones, cellular telephones, and/or other telephones.

As shown in FIG. 2, an exemplary computer system to use for implementing one or more parts of telephone system 20 includes a computing device, such as computing device 100. In one implementation, one or more parts of telephony application (32a or 32b), virtual operator application 33, and/or central contacts database 34 are operated on a device such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 2 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 2 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

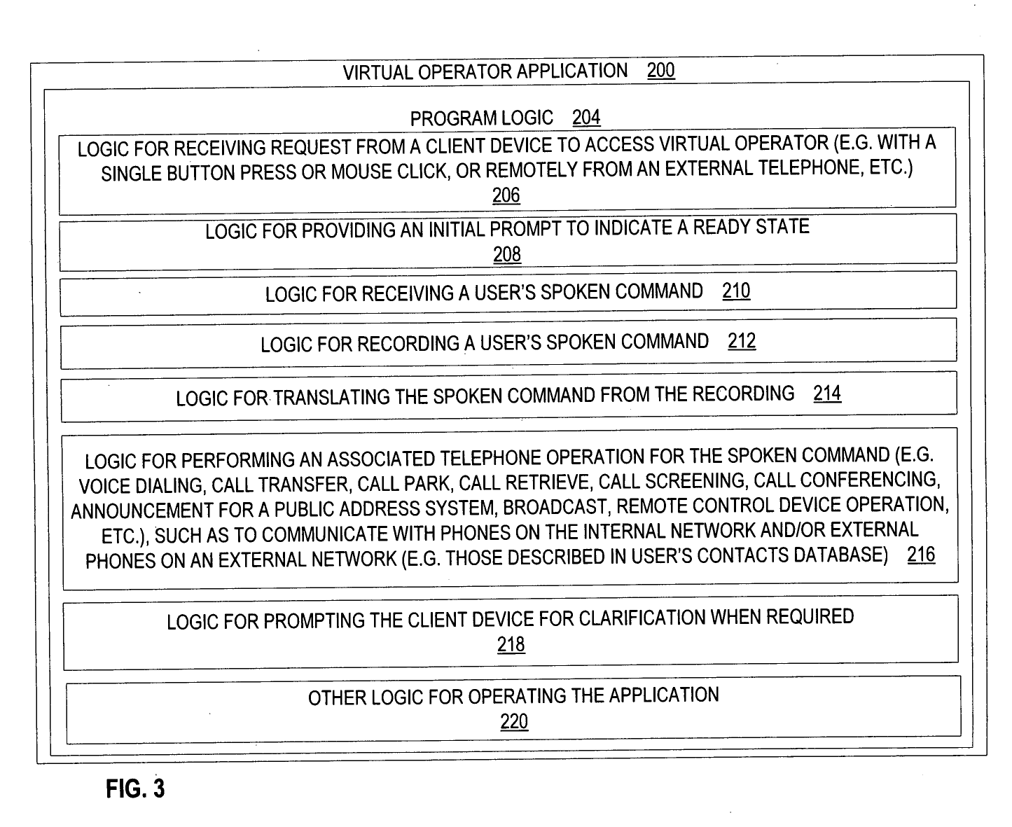

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes virtual operator application 200. Virtual operator application 200 will be described in further detail in FIG. 3.

Turning now to FIG. 3 with continued reference to FIGS. 1 and 2, a virtual operator application 200 operating on a computing device (such as computing device 100) is illustrated. In one implementation, virtual operator application 200 is one of the application programs that reside on computing device 100. However, it will be understood that virtual operator application 200 can alternatively or additionally be embodied as computer-executable instructions on one or more computers and/or in different variations than shown on FIG. 2. Alternatively or additionally, one or more parts of virtual operator application 200 can be part of system memory 104, on other computers and/or applications 115, or other such variations as would occur to one in the computer software art.

Virtual operator application 200 includes program logic 204, which is responsible for carrying out some or all of the techniques described herein. Program logic 204 includes logic for receiving a request from a client device to access virtual operator (such as with a single button press or mouse click, or remotely from an external telephone) 206; logic for providing an initial prompt to indicate a ready state 208; logic for receiving a user's spoken command 210; logic for recording a user's spoken command 212; logic for translating the spoken command from the recording 214; logic for performing an associated telephone operation for the spoken command (e.g. voice dialing, call transfer, call park, call retrieve, call screening, call conferencing, announcement for a public address system, broadcast, remote control device operation, etc.), such as to communicate with phones on the internal network and/or external phones on an external network (e.g. those described in user's contacts database) 216; logic for prompting the client device for clarification when required 218; and other logic for operating the application 220. In one implementation, program logic 204 is operable to be called programmatically from another program, such as using a single call to a procedure in program logic 204.

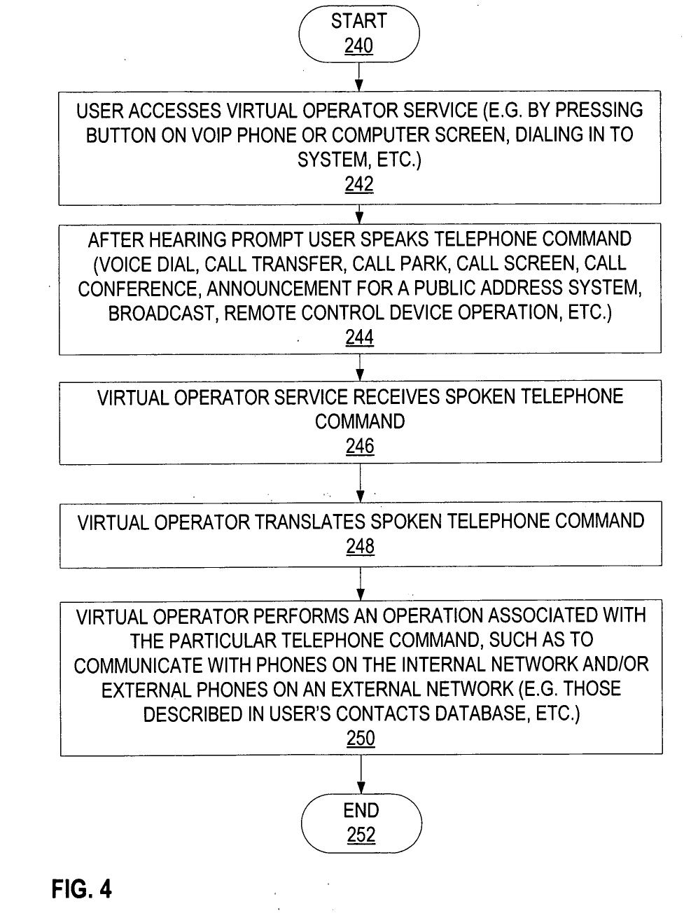

Turning now to FIGS. 4-12 with continued reference to FIGS. 1-3, the stages for implementing one or more implementations of system 20 are described in further detail. FIG. 4 is a high level process flow diagram for system 20. In one form, the process of FIG. 4 is at least partially implemented in the operating logic of computing device 100. The procedure begins at start point 240 with the user accessing virtual operator service, such as by pressing a button on a voice-over-IP telephony phone or a computer screen, by dialing in to the system remotely, etc. (stage 242). The user speaks a telephone command (voice dial, call transfer, call park, call screen, call conference, an announcement for a public address system, broadcast, remote control device operation command, etc.), such as after hearing a prompt from the virtual operator (stage 244). The virtual operator service receives a spoken telephone command (stage 246) and translates the spoken telephone command (stage 248). The virtual operator performs an operation associated with the particular telephone command, such as to communicate with phones on the internal network and/or external phones on an external network (e.g. those described in user's contacts database, etc.) (stage 250). The process ends at end point 252.

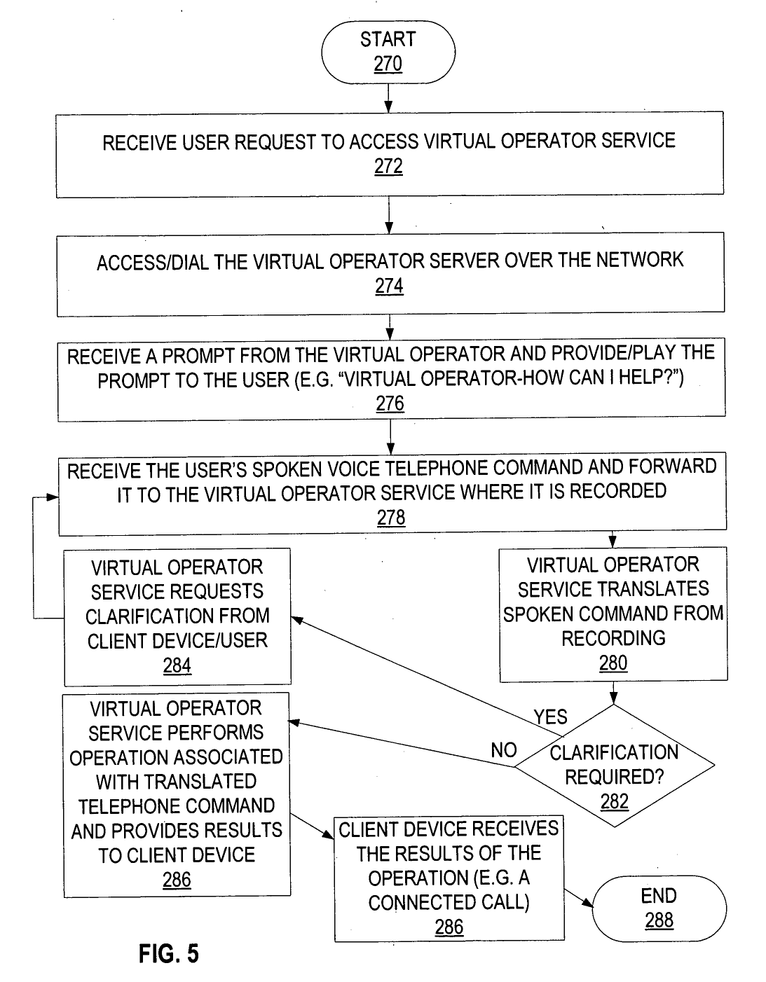

FIG. 5 illustrates one implementation of the stages involved in accessing a virtual operator from a client device. In one form, the process of FIG. 5 is at least partially implemented in the operating logic of computing device 100. The procedure begins at start point 270 with receiving a user request to access a virtual operator service (stage 272). The virtual operator server is accessed/dialed over the network (stage 274). A prompt is received from the virtual operator and provided/played to the user (e.g. “virtual operator-how can I help?” (stage 276). The user's spoken voice telephone command is received and forwarded to the virtual operator service where it is recorded (stage 278). The virtual operator service translates the user's spoken command from the recording (stage 280). If clarification is required (i.e. no matching operation was found or more than one matching operation was found) (decision point 282), then the virtual operator service requests clarification from the client device/user (stage 284). Once clarification is no longer needed (or if it was never needed at all), then the virtual operator service performs an operation associated with the telephone command (stage 286). The client device receives the results of the command, such as a connected call (stage 287). The process ends at end point 288.

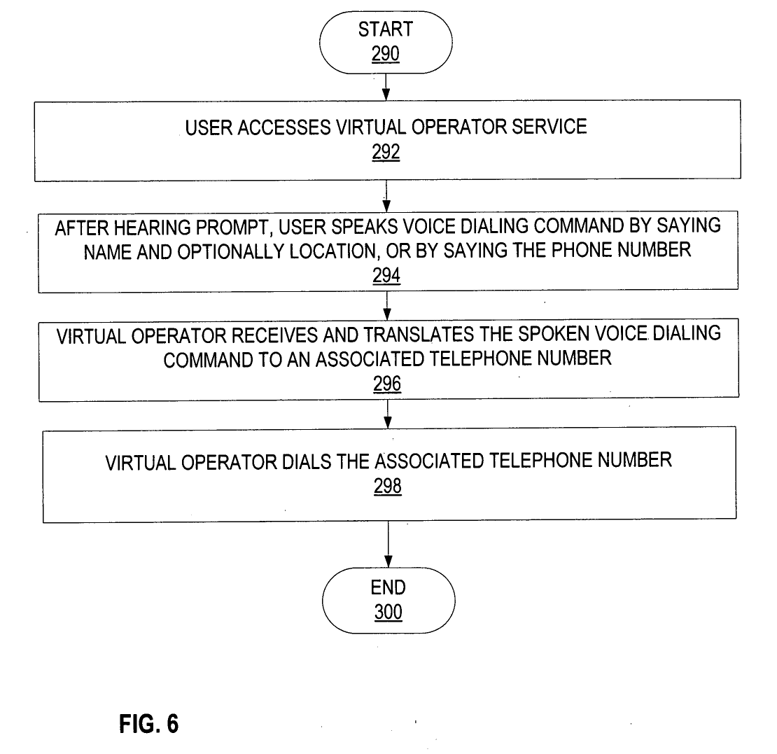

FIG. 6 illustrates one implementation of the stages involved in performing a voice dialing action using the virtual operator. In one form, the process of FIG. 6 is at least partially implemented in the operating logic of computing device 100. The procedure begins at start point 290 with the user accessing the virtual operator service (stage 292). After hearing a prompt, the user speaks a voice dialing command by saying a name and optionally a location, or by saying a phone number (stage 294). The virtual operator receives and translates the spoken voice dialing command to an associated telephone number (stage 296). The virtual operator dials the associated telephone number (stage 298) and connects the client device to the call. The process ends at end point 300.

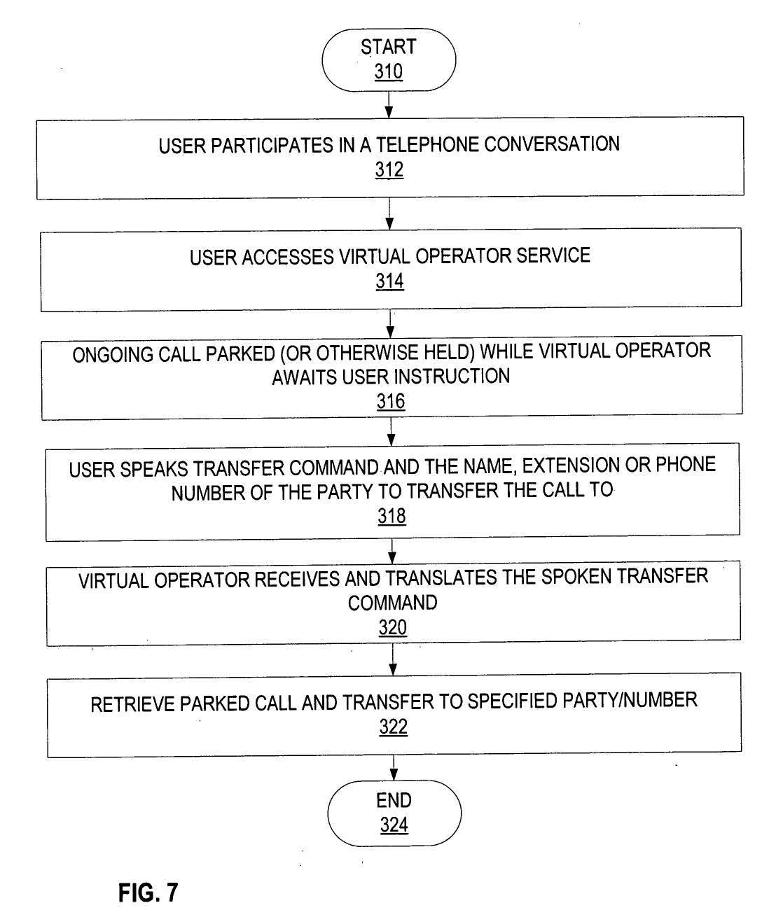

FIG. 7 illustrates one implementation of the stages involved in performing a call transfer action using a virtual operator. In one form, the process of FIG. 7 is at least partially implemented in the operating logic of computing device 100. The procedure begins at start point 310 with the user participating in a telephone conversation (stage 312). The user accesses the virtual operator service (stage 314). The ongoing call is parked (or otherwise held) while the virtual operator awaits the user's instruction (stage 316). The user speaks a transfer command and the name, extension or phone number of the party to transfer the call to (stage 318). The virtual operator receives and translates the spoken transfer command (stage 320). The parked call is retrieved and transferred to the specified party/number (stage 322). The process ends at end point 324.

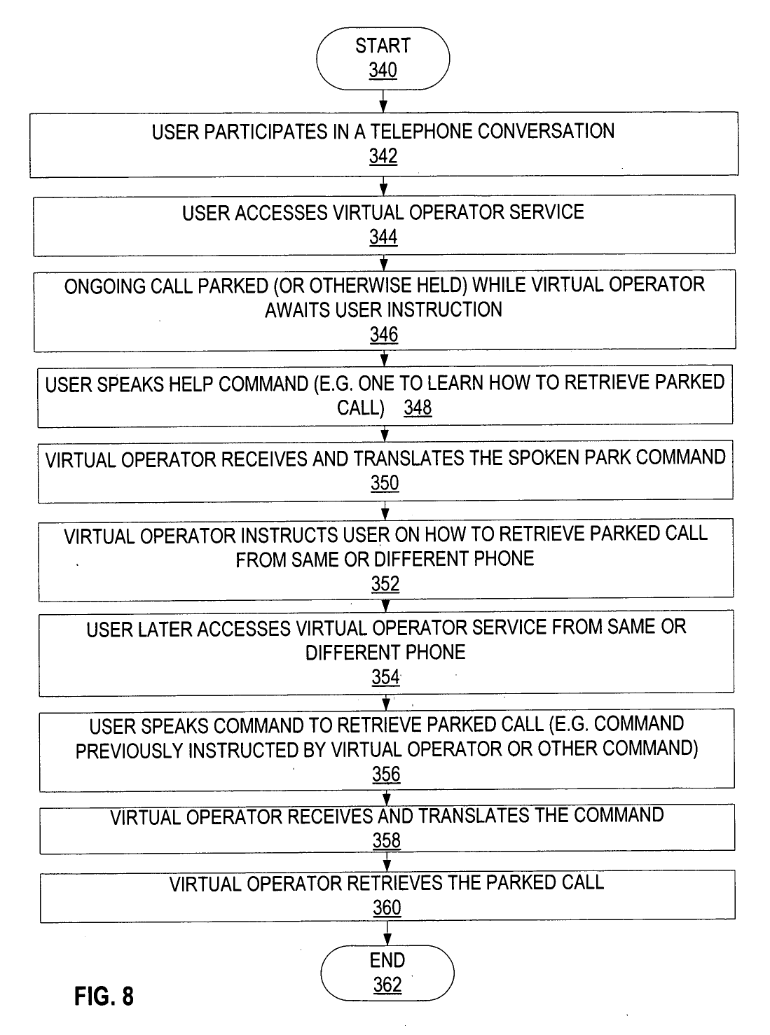

FIG. 8 illustrates one implementation of the stages involved in performing a help action to help instruct a user on retrieving a parked call using a virtual operator. In one form, the process of FIG. 8 is at least partially implemented in the operating logic of computing device 100. The procedure begins at start point 340 with the user participating in a telephone conversation (stage 342). The user accesses the virtual operator service (stage 344). The ongoing call is parked (or otherwise held) while the virtual operator awaits the user's instruction (stage 346). The user speaks a help command (e.g. for learning how to retrieve a parked call) (stage 348). The virtual operator receives and translates the spoken park command (stage 350). The virtual operator instructs the user on how to retrieve the parked call from the same or different phone (stage 352). The user later accesses the virtual operator service from the same or different phone (stage 354). The user speaks the command to retrieve the parked call (e.g. command previously instructed by virtual operator or other command) (stage 356). The virtual operator receives and translates the command (stage 358). The virtual operator retrieves the parked call (stage 360). The process ends at end point 362.

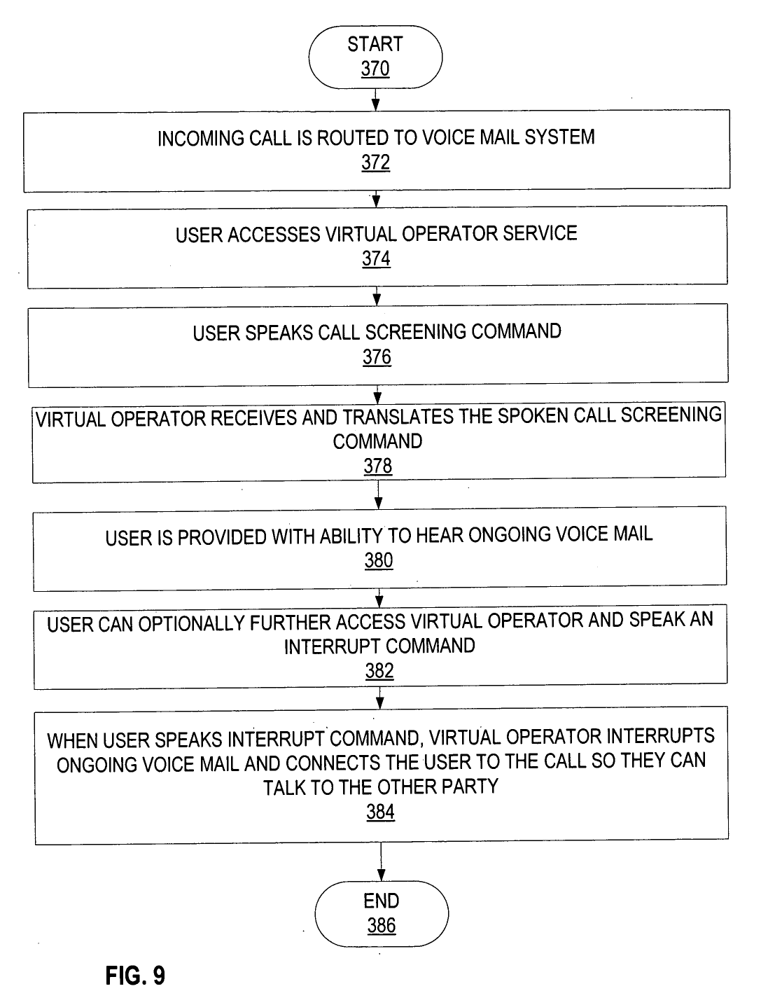

FIG. 9 illustrates one implementation of the stages involved in performing a call screening action using a virtual operator. In one form, the process of FIG. 9 is at least partially implemented in the operating logic of computing device 100. The procedure begins at start point 370 with the incoming call being routed to a voice mail system (stage 372). The user accesses the virtual operator service (stage 374). The user speaks a call screening command (stage 376). The virtual operator receives and translates the spoken call screening command (stage 378). The user is provided with the ability to hear the ongoing voice mail message that is being left by the calling party (stage 380). The user can optionally further access the virtual operator and speak an interrupt command (stage 382). When the user speaks the interrupt command, the virtual operator interrupts the ongoing voice mail and connects the user to the call so they can talk to the other party (stage 384). The process ends at end point 386.

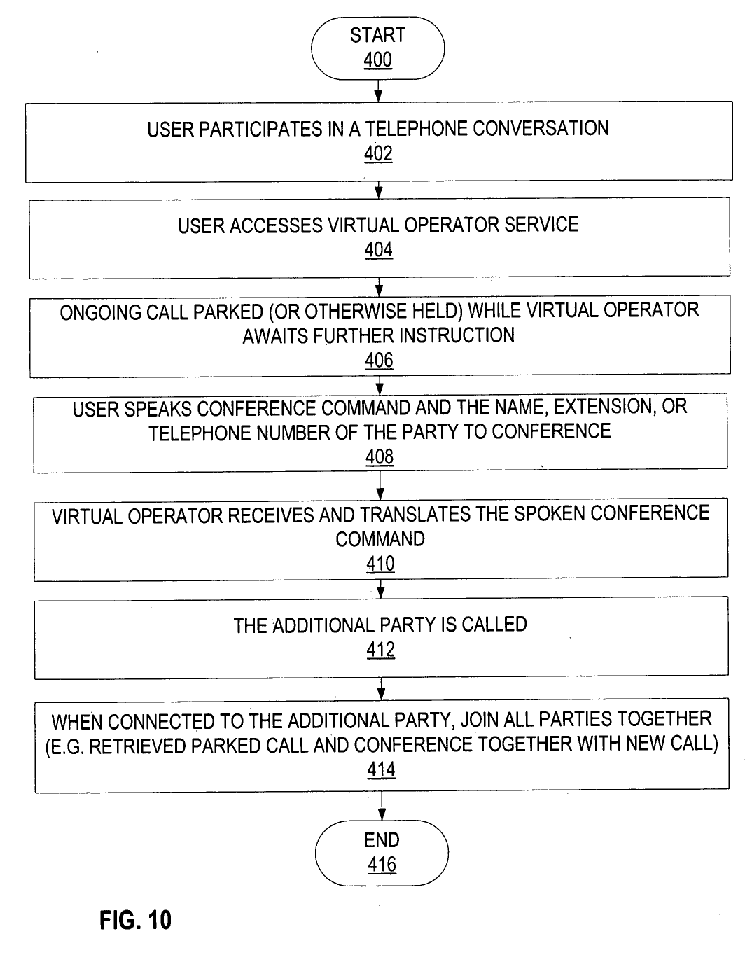

FIG. 10 illustrates one implementation of the stages involved in performing a call conferencing action using a virtual operator. In one form, the process of FIG. 10 is at least partially implemented in the operating logic of computing device 100. The procedure begins at start point 400 with the user participating in a telephone conversation (stage 402). The user accesses the virtual operator service (stage 404). The ongoing call is parked (or otherwise held) while the virtual operator awaits further instruction (stage 406). The user speaks the conference command and the name, extension, or telephone number of the party to conference (stage 408). The virtual operator receives and translates the spoken conference command (stage 410), and the additional party is called (stage 412). When connected to the additional party, all parties are joined together (e.g. parked call is retrieved and conferenced together with a new call) (stage 414). The process ends at end point 416.

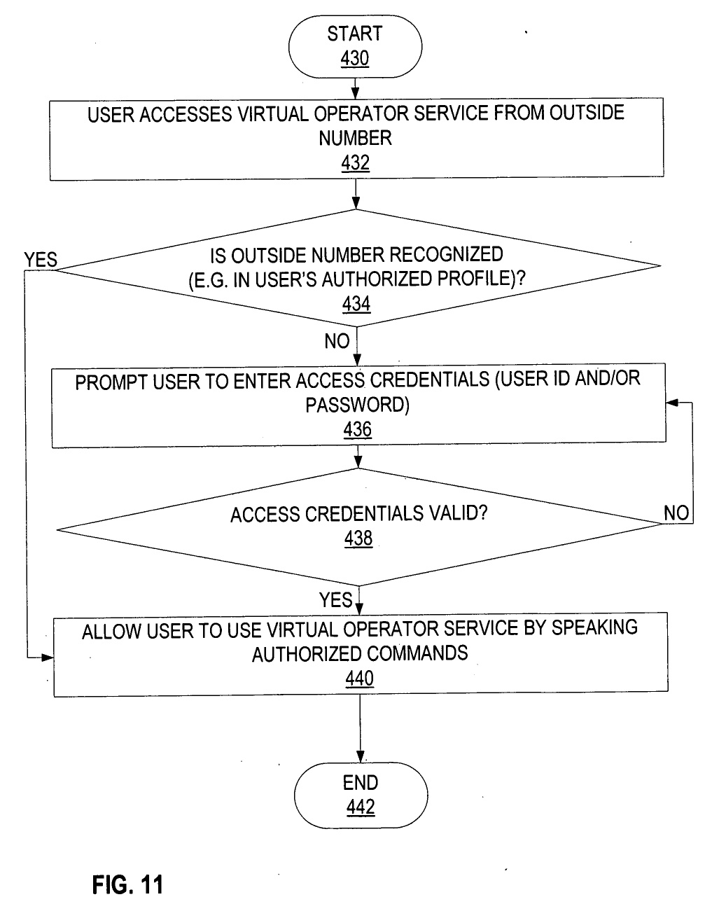

FIG. 11 illustrates one implementation of the stages involved in accessing a virtual operator service from an external phone. In one form, the process of FIG. 11 is at least partially implemented in the operating logic of computing device 100. The procedure begins at start point 430 with the user accessing the virtual operator service from an outside number (stage 432). If the outside number is recognized (e.g. the number from which the call is placed is in user's authorized profile) (decision point 434), then the user is provided access to the virtual operator service by speaking authorized commands (stage 440). If the outside number is not recognized (decision point 343), then the user is prompted to enter access credentials, such as a user id and/or password (stage 436). If the access credentials are valid (decision point 438), then the user is provided access to the virtual operator service by speaking authorized commands (stage 440). The process ends at end point 442.

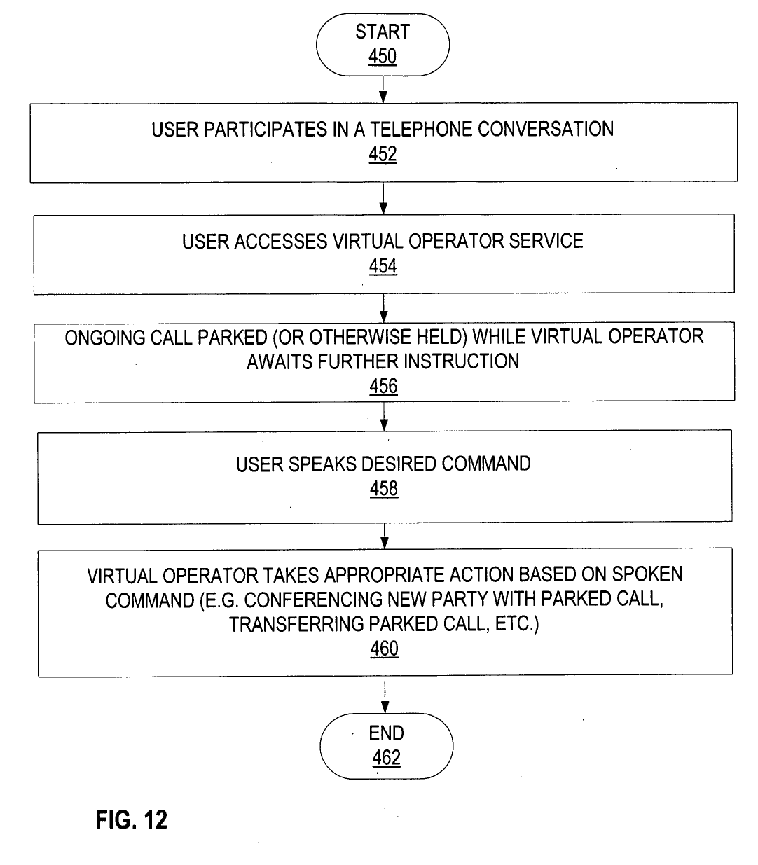

FIG. 12 illustrates one implementation of the stages involved in allowing the user to access the virtual operator during an ongoing call. In one form, the process of FIG. 12 is at least partially implemented in the operating logic of computing device 100. The procedure begins at start point 450 with the user participating in a telephone conversation (stage 452). The user accesses the virtual operator service (stage 454). The ongoing call is parked (or otherwise held) while the virtual operator awaits further instruction (stage 456). The user speaks the desired command (stage 458) and the virtual operator takes an appropriate action based on spoken command (stage 460), such as conferencing a new party with a parked call, transferring a parked call, etc. The process ends at end point 462.

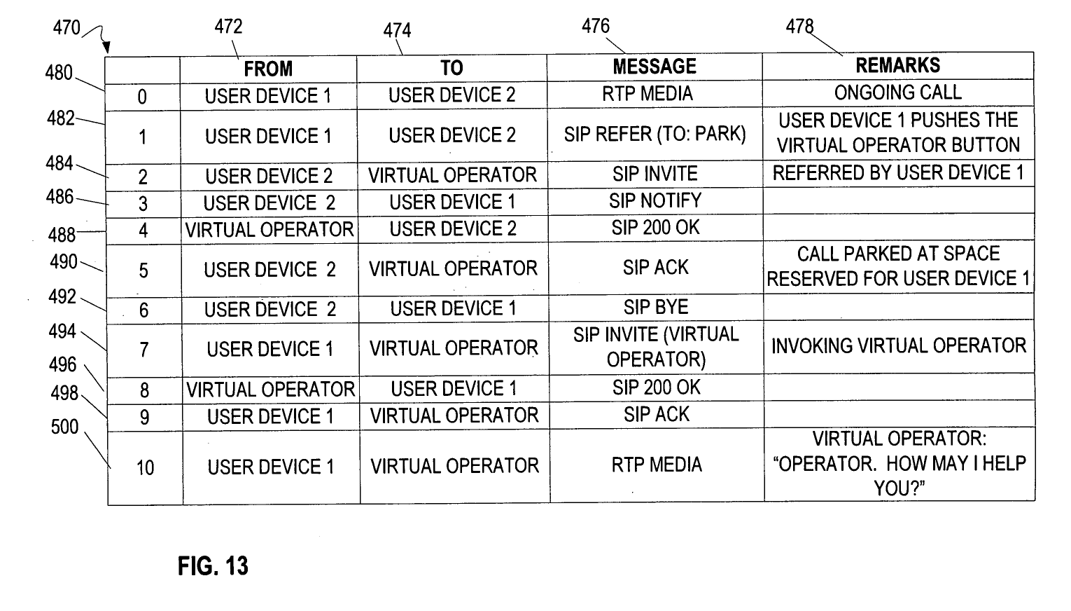

FIG. 13 is a logical diagram 470 of one implementation illustrating a hypothetical flow of messages using various Session Initiation Protocol (SIP) and other message types when the virtual operator is invoked. Logical diagram 470 illustrates who the message is from 472, who the message is to 474, the type of message 476, and some comments about the communication 478. The first communication starts at stage 0 (480) with the user device 1 having an ongoing communication with user device 2, such as of a RTP media type. In stage 1 (482), user device 1 communicates with user device 2 using the SIP REFER command to park the call, such as when user device 1 pushes the virtual operator button. In stage 2 (484), user device 2 accesses the virtual operator service using a SIP INVITE message. In stage 3 (486), user device 2 communicates with user device 1 with a SIP NOTIFY message. The virtual operator communicates with user device 2 in stage 4 (488) with a SIP 200 OK command. In stage 5 (490), user device 2 communicates with the virtual operator service with a SIP ACK command to park the call at a space reserved for user device 1. User device 2 communicates with user device 1 with a SIP BYE command at stage 6 (492).

The prior steps are used when an ongoing call is in process prior to invoking the virtual operator. The following steps and message flows are invoked whether or not an ongoing call was already ensuing. At stage 7 (494), user device 1 communicates with the virtual operator with a SIP INVITE message to invoke the virtual operator service. The virtual operator communicates with user device 1 with a SIP 200 OK at stage 8 (496). The user device 1 then communicates with the virtual operator with a SIP ACK message at stage 9 (498). The user device 1 then communicates with virtual operator with an RTP media message at stage 10 (500).

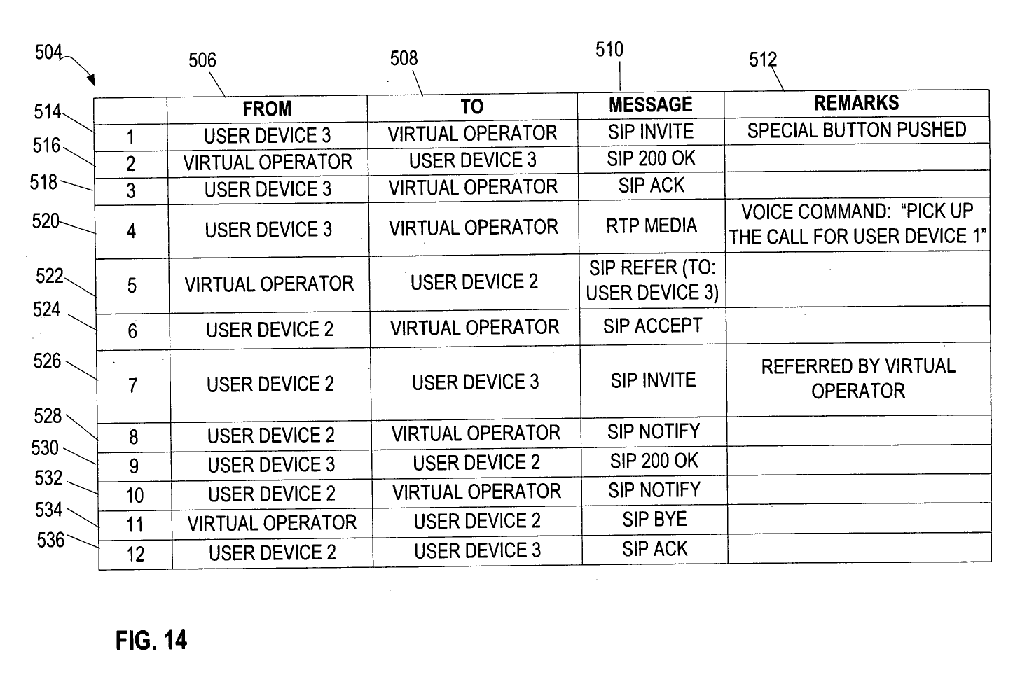

FIG. 14 is a logical diagram 504 of one implementation illustrating a hypothetical flow of messages using various SIP and other message types when a parked call is routed to another extension. Diagram 504 illustrates who the message is from 506, who the message is to 508, the type of message 510, and remarks 512. At stage 1 (514), user device 3 sends a SIP invite command to virtual operator, such as when a special virtual operator button is pushed. The virtual operator response to user device 3 with a SIP 200 OK message at stage 2 (516). User device 3 then sends a SIP ACK message to the virtual operator at stage 3 (518). At stage 4 (520), user device 3 sends an RTP media message to the virtual operator, such as a voice command that says “Pick up the call for user device 1”. At stage 5 (522), the virtual operator sends a SIP REFER (TO: USER DEVICE 3) message to user device 2. The user device 2 sends a SIP ACCEPT command to the virtual operator at stage 6 (524). The user device 2 at stage 7 (526) then communicates with user device 3 with a SIP INVITE message that was referred by the virtual operator. The user device 2 sends a SIP NOTIFY command to the virtual operator at stage 8 (528). The user device 3 then sends user device 2 a SIP 200 OK message at stage 9 (530). User device 2 sends a SIP NOTIFY to the virtual operator at stage 10 (532), and the virtual operator responds to the user device 2 with a SIP BYE message at stage 11 (534). User device 2 sends a SIP ACK message to user device 3 at stage 12 (536).

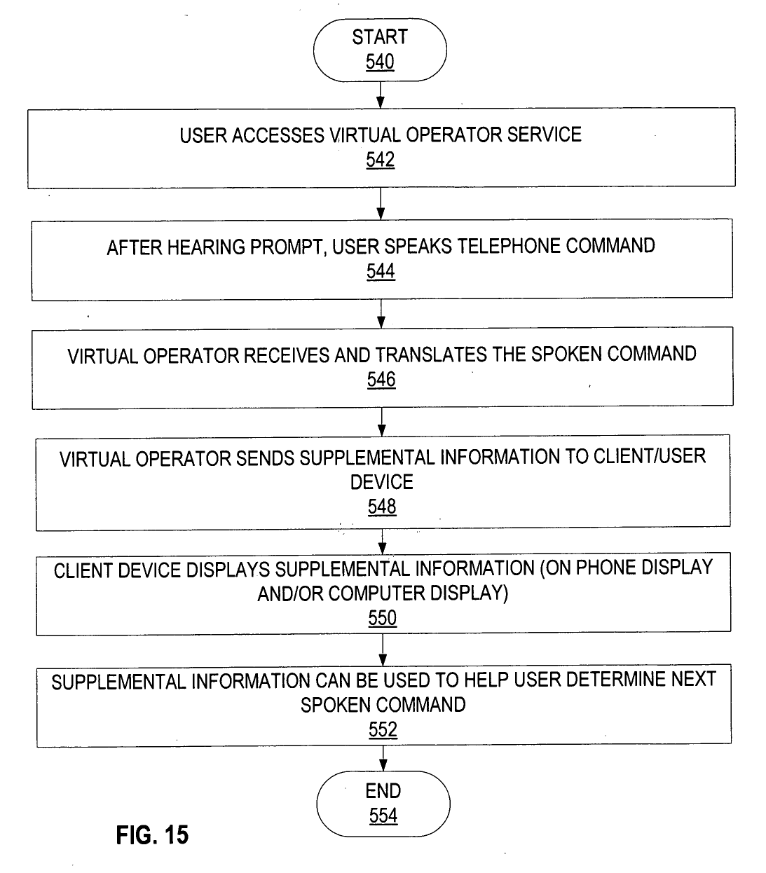

FIG. 15 illustrates one implementation of the stages involved in providing supplemental info to help the user determine the next spoken word. In one form, the process of FIG. 15 is at least partially implemented in the operating logic of computing device 100. The procedure begins at start point 540 with the user accessing the virtual operator service (stage 542). After hearing a ready prompt, the user speaks a telephone command (stage 544). The virtual operator receives and translates the spoken command (stage 546). The virtual operator sends supplemental information to the client/user device (stage 548). The client device displays supplemental information, such as on the phone display and/or computer display (stage 550). The supplemental information can be used to help the user determine the next spoken command (stage 552). As one non-limiting example, if more than one number matched the name for a person the user asked the virtual operator to call, then supplemental information can be displayed to help the user narrow down the choice and speak an additional clarification command. As another non-limiting example, if the virtual operator is unsure of the command spoken by the user, a few possible options may be displayed on the screen to help the user further decide what command to speak next. The process ends at end point 554.

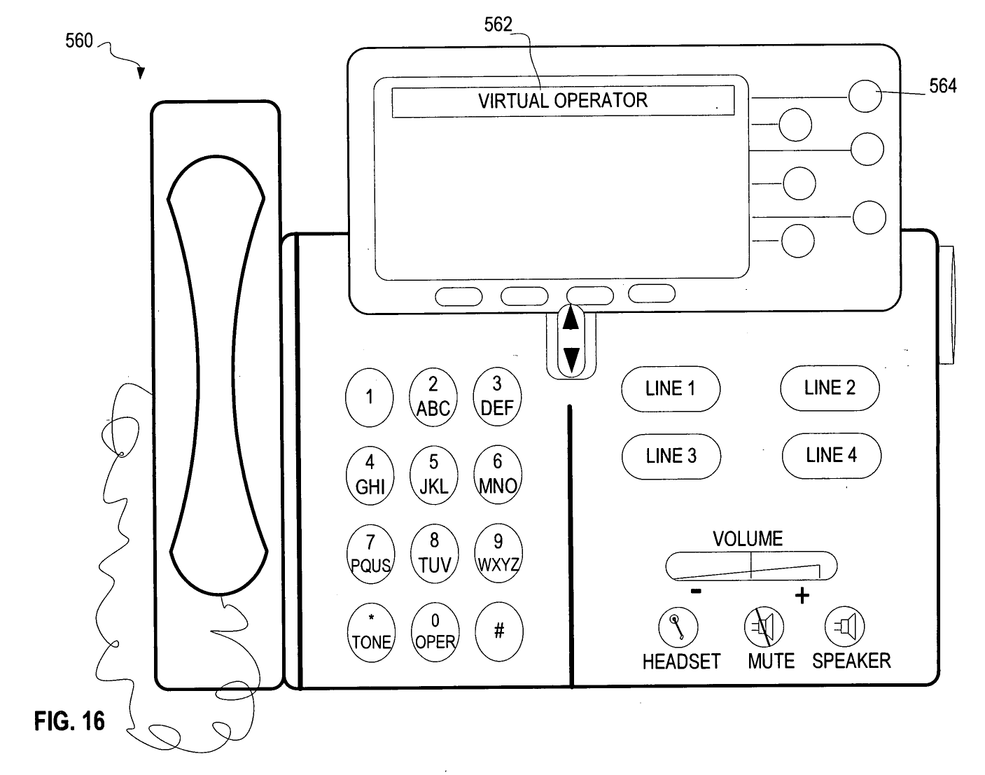

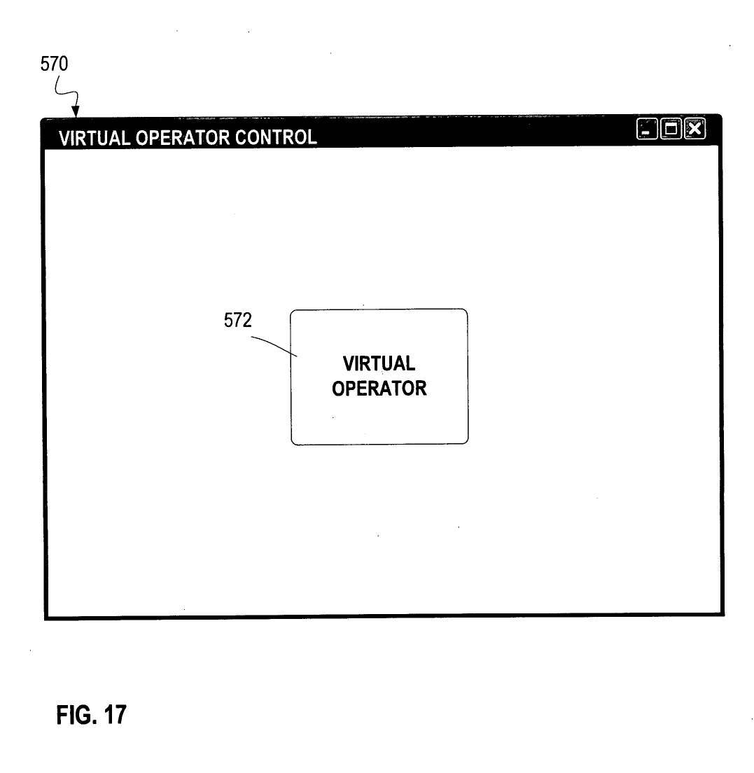

FIG. 16 is a diagram of a simulated telephone of one implementation of system 20 that illustrates accessing the virtual operator using a single button. Telephone 560 includes a virtual operator indicator 562 on the display of the phone, and upon pressing button 564, the virtual operator service 33 is invoked over network 22 on server 24. FIG. 17 is a simulated screen 570 for another implementation of system 20 that illustrates accessing the virtual operator using a single button on a computer screen. Virtual operator service 33 can be accessed by the user upon pressing the virtual operator button 572, or by selecting the virtual operator button 572 with another input device such as a mouse or keyboard.

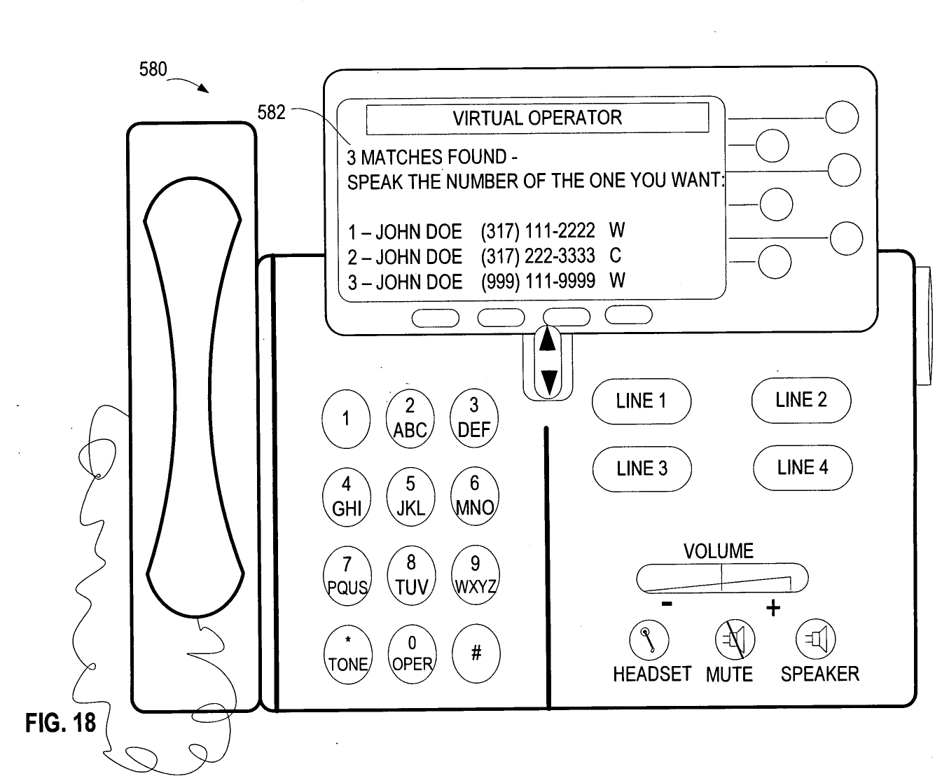

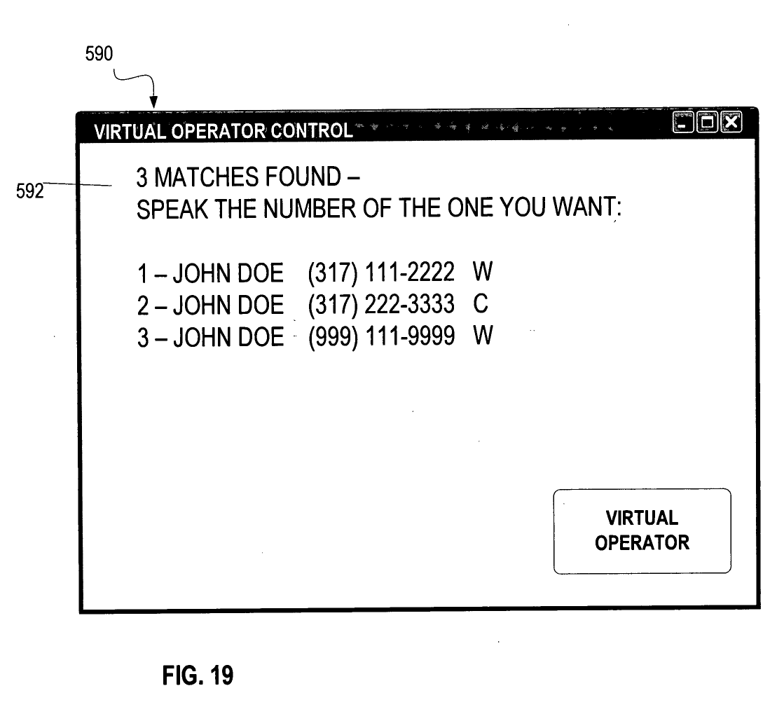

FIG. 18 is a diagram of a simulated telephone of one implementation of system 20 that illustrates providing supplemental information to help the user provide further spoken commands. In the example shown, telephone 580 has a display that illustrates additional information 582 regarding the user's requested command. In this example, the screen 582 indicates that 3 matches were found for John Doe. The user can review the information on screen 582 to help determine the next telephone command to speak, such as “Dial John Doe #1”. FIG. 19 is a simulated screen 590 for another implementation of system 20 that illustrates providing supplemental information on a computer display to help the user give further spoken commands. The example shown is the same hypothetical discussed in FIG. 18, and includes the additional information 592 about the multiple matches found for John Doe.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for providing a virtual operator comprising the steps of:
receiving a single input from a user to access a virtual operator service;
accessing the virtual operator service over a network;
receiving a prompt from the virtual operator and providing the prompt to the user;
receiving a spoken telephone command from the user, the spoken command being associated with a telephone operation selected from the group consisting of a voice dialing operation, a call transfer operation, a call park operation, a call retrieve operation, a call screening operation, a call conferencing operation, an announcement for a public address system operation, a broadcast operation, and a remote control device operation;
forwarding the spoken telephone command to the virtual operator; and
receiving a result of the spoken telephone command from the virtual operator.

2. The method of claim 1, wherein the single input is a button press on a telephony phone.

3. The method of claim 1, wherein the single input is a mouse click on a display device of a telephony application.

4. The method of claim 3, wherein the telephony application operates on a computing device coupled to a telephony phone.

5. The method of claim 3, wherein the telephony application operates on a telephony phone.

6. The method of claim 1, wherein the result of the spoken telephone command includes communicating with a party on an internal telephone network or an external telephone network.

7. The method of claim 1, wherein the prompt is a voice prompt from the virtual operator to indicate the virtual operator is ready to receive the spoken telephone command.

8. The method of claim 1, wherein the result received from the virtual operator is a connected call.

9. The method of claim 1, wherein the result is a request for further clarification of the spoken telephone command.

10. The method of claim 9, further comprising:
receiving a spoken telephone clarification command from the user and forwarding the spoken telephone clarification command to the virtual operator.

11. The method of claim 10, further comprising:
receiving a clarification result of the spoken telephone clarification command from the virtual operator.

12. The method of claim 11, wherein the clarification result received from the virtual operator is a connected call.

13. A computer-readable medium having computer-executable instructions for causing a computer to perform the steps recited in claim 1.

14. A computer-readable medium having computer-executable instructions for causing a computer to perform steps comprising:
receive a request from a client device to access a virtual operator;
receive a spoken command from the client device;
record the spoken command;
translate the spoken command from the recording; and
perform a telephone call operation associated with the translated spoken command, the operation being selected from the group consisting of a voice dialing operation, a call transfer operation, a call park operation, a call retrieve operation, a call screening operation, a call conferencing operation, an announcement for a public address system operation, a broadcast operation, and a remote control device operation.

15. The computer-readable medium of claim 14, wherein the virtual operator is operable to receive the request remotely from the client device from an external telephone located outside an internal computer network of the virtual operator.

16. The computer-readable medium of claim 14, further having computer-executable instructions for causing a computer to perform the step comprising:
if the translated spoken command does not match a list of available commands, then prompt the client device for a clarification command.

17. A method for accessing a virtual operator service during an ongoing telephone call comprising the steps of:
providing an ongoing telephone call;
receiving input from a user to access a virtual operator service over a network;
parking the ongoing telephone call while the virtual operator service awaits further instruction from the user;
receiving a spoken telephone command from the user; and
taking an appropriate telephone action based on the spoken telephone command.

18. The method of claim 17, wherein the spoken telephone command is a conference operation and wherein the appropriate telephone action includes conferencing a new party with the parked telephone call.

19. The method of claim 17, wherein the spoken telephone command is a call transfer operation and wherein the appropriate telephone action includes transferring the parked telephone call to a different telephone number.

20. A computer-readable medium having computer-executable instructions for causing a computer to perform the steps recited in claim 17.
